(19) United States
(12) Patent Application Publication
(10) Pub. No.: US 2026/0329232 A1
(43) Pub. Date: Oct. 22, 2026

(54) TIMEPIECE COMPONENT AND METHOD FOR MANUFACTURING SUCH A TIMEPIECE COMPONENT

(71) Applicant: ROLEX SA, Geneva (CH)

(72) Inventors: Pierre Huguet, Allinges (FR); Pierre Di Luna, Veigy-Foncenex (FR); Maria Isabel Borges Machado, Thônex (CH); Ollivier Pujol, Lausanne (CH)

(73) Assignee: ROLEX SA, Geneva (CH)

(21) Appl. No.: 19/100,540

(22) PCT Filed: Aug. 2, 2023
(86) PCT No.: PCT/EP2023/071448

§ 371 Date: Feb. 19, 2025

(30) Foreign Application Priority Data
Aug. 2, 2022 (EP) 22188303.6

(51) Int. Cl. G04B 19/28; G04B 45/00; G04D 3/00

(52) U.S. Cl. CPC G04B 19/283; G04B 45/0015; G04D 3/0092

(57) ABSTRACT

The timepiece component includes a substrate (11) made of an at least partially transparent material, a first coloured enamel layer (12) applied to the substrate (11), in particular applied by transfer to the substrate (11), in particular by chromo decal onto the substrate (11), and a second finishing layer (13), in particular a second opacifying finishing layer (13), applied at least partially to the first coloured enamel layer (12).

The invention concerns a timepiece component. The invention also concerns a timepiece comprising such a timepiece component. The invention finally concerns a method for manufacturing such a timepiece component.

In the timepiece field, notably in the watch exterior component field, it is looked for obtaining in a reliable, robust and repeatable manner a decorated and durable bezel disc, that is to say a disc the decoration of which can be varied without limitation of the choice of colors or their associations, for a monochrome or multicolored result, with any design, resistant to ageing and to environmental damage (scratches, UV rays, etc.) and without the engineering of the timepieces having to be adapted to achieve these objectives.

The documents CH707424A2 and CH707423A2 describe the production of components in an opaque technical ceramic (alumina or zirconia, for example) with a decoration produced by impregnation of metallic salts on the face of the component visible to the user of the timepiece. It is difficult using the methods described to obtain all color combinations.

The patent EP1734420B1 described a transparent watch glass locally enameled on its lower face so as to participate in masking the system for assembling the glass to the middle case. In this patent there is mainly claimed a sealed case comprising a middle and a back delimiting an housing closed by a glass made of a transparent material resistant to temperatures above 500 °C, glued or welded at the level of junction zones at least partly covering the shoulder of the middle, wherein the internal face of the glass includes an enamel deposit formed at the level of the junction zones.

The patent CH320817 describes a rotating bezel comprising a transparent disc the lower face of which is both:
recessed in order to form hour markers (signs), the recesses being coated with a metallic deposit coloring the hour markers, and
coated, for example with a varnish, in order to impart a colored appearance to the disc outside the recesses.

The transparent disc allows metallic color signs to be seen, contrasting with the color applied to its lower face. An example is given in which this color is that of a varnish.

The document WO2006/133810A1 discloses a component comprising a transparent substrate decorated by enamel layers disposed in recesses and the method of obtaining them. Variations of the shades of enamel described in that document are generated by variations of the enamel thickness, controlled by the depth of the recesses in which it is deposited (these recesses being on the faces and/or on the side of the components). This produces a range of shades for a single composition of the enamel.

The aim of the invention is to provide a timepiece component enabling improvement of the components known in the prior art. In particular, the invention proposes a timepiece component that can be decorated in a simple manner and offers great durability of the decoration produced on the component without it being necessary to design the rest of the timepiece with dedicated means for forming and protecting the decorated surface.

Objects of a first aspect of the invention are defined by the following propositions.
1. A timepiece component (1) comprising:
   a substrate (11) made of an at least partly transparent material, and
   a first layer of colored enamel (12) applied onto the substrate (11) by means of a transfer in particular onto the substrate (11) by means of a chromo decal.
2. The timepiece component (1) according to proposition 1, wherein the timepiece component (1) comprises a second, finishing layer (13), notably a second, opacifying finishing layer (13) applied at least in part onto the first layer (12) of colored enamel.
3. The timepiece component (1) according to proposition 1 or 2, wherein the substrate is made of an inorganic material such as a technical ceramic, quartz, spinel, magnesium aluminate, AlON, YAG, cubic zirconia, mineral glass, polycrystalline alumina, vitroceramic, monocrystalline alumina and/or the substrate has at least locally a real in-line transmittance for light at a wavelength of 550 nm greater than 60% or 70% or 80% or 85%.
4. The timepiece component (1) according to any one of propositions 1 to 3, wherein the substrate has a hardness greater than 800 Hv or 1000 Hv.
5. The timepiece component (1) according to any one of propositions 1 to 4 and proposition 2, wherein the second, finishing layer is:
   a layer of enamel, notably a layer of enamel applied by means of a transfer, and/or
   a metal-based layer, notably deposited by PVD, CVD, ALD, PLD,
and/or
   a layer of another coating, such as paint.
6. The timepiece component (1) according to any one of propositions 1 to 5, wherein the timepiece component (1) is an exterior casing component for a timepiece (100), such as in particular:
   a glass,
   a back,
   a bezel disc,
   a wrist band element, or
   a middle,
or the timepiece component (1) is an internal component for a timepiece (100), such as in particular:
   a dial,
   a flange, or
   a disc for displaying timepiece information.
7. The timepiece component (1) according to any one of propositions 1 to 6, wherein:
   the substrate (11) comprises a first surface (111) and a second surface (112), in particular a second surface (112) parallel or substantially parallel to a first surface (111),
   the first layer (12) and/or the second layer (13) is or are applied onto the first surface (111), and
   the first surface (111), in particular the first layer and/or the second layer applied onto the first surface, can be seen through the second surface (112) and the substrate (11).
8. The timepiece component (1) according to proposition 7, wherein the substrate (11) comprises at least one second recess (15) produced on the second surface (112), notably at least one second recess (15) produced by laser machining.
9. The timepiece component (1) according to proposition 8, wherein the at least one second recess (15) is coated, in particular coated with a metal-based layer, in particular coated with a metal-based layer deposited by PVD, CVD, ALD or PLD.
10. The timepiece component (1) according to any one of propositions 7 to 9, wherein the substrate (11) has an antireflection treatment on the second surface (112).
11. The timepiece component (1) according to any one of propositions 1 to 10 and proposition 7, wherein the substrate (11) comprises at least one first recess (14) produced on the first surface (111) after application of the first and second layers, notably at least one first recess (14) produced by laser machining.
12. The timepiece component (1) according to proposition 11, wherein the at least one first recess (14) is coated, in particular coated with a metal-based layer, in particular coated with a metal-based layer deposited by PVD, CVD, ALD or PLD.
13. The timepiece component (1) according to proposition 11 or 12, wherein the at least one first recess (14) is such that the area of material removed by ablation at the level of a plane perpendicular to a direction in which the at least one first recess is formed, is arranged between:
   the surface from which the at least one first recess is formed, notably the lower surface (111) or a surface of the first layer (12) or a surface of the second layer (13), and
   a surface defining the bottom of the at least one first recess, and evolves in the direction in which the at least one first recess is formed,
and/or
is such that the area of material removed by ablation at the level of any plane parallel to the direction in which the at least one first recess is formed evolves in a direction orthonormal to the direction in which the at least one first recess is formed.
14. The timepiece component (1) according to any one of propositions 11 to 13, wherein the at least one first recess (14) has a millimeter or micrometer or nanometer scale area, notably at the level of a surface defining the bottom of the recess and/or at the level of the surface from which it is formed.
15. A method of producing a timepiece component (1), the method comprising the following steps:
   obtaining a substrate (11) made of an at least partly transparent material, and
   applying a first layer of colored enamel (12) onto the substrate (11) by means of a transfer, in particular onto the substrate (11) by means of a chromo decal.
16. The method according to proposition 15, wherein the method comprises the application of a second, finishing layer (13), notably of a second, opacifying finishing layer (13), at least in part onto the first layer (12) of colored enamel.
17. The production method according to proposition 16, wherein the application of the second layer is:
   an application of a layer of enamel, notably application of a layer of enamel by means of a transfer, in particular by means of a chromo decal, and/or
   an application of a metal-based layer, notably by PVD, CVD, ALD, PLD, and/or
   an application of a layer of another coating, such as paint.
18. The production method according to any one of propositions 15 to 17, wherein it comprises a step of producing at least one first recess (14) on a first surface (111) of the substrate (11), notably at least one first recess (14) produced by laser machining, and/or it comprises a step of producing at least one second recess (15) on a second surface (112) of the substrate (11), notably at least one second recess (15) produced by laser machining.
19. The production method according to proposition 18, wherein the step of producing at least one first recess and/or the step of producing at least one second recess is or are carried out after the step of application of the first layer of enamel (12) onto the substrate (11), and, in the step of producing at least one first recess and/or in the step of producing at least one second recess, a decoration formed by the first layer of enamel is used as a marker, notably as a machining marker.
20. The production method according to either one of propositions 18 or 19, wherein the method comprises a step of coating the at least one first recess (14) and/or the at least one second recess (15), notably with a metal-based layer, in particular with a metal-based layer deposited by PVD, CVD, ALD or PLD.
21. A timepiece component (1) obtained using the method according to any one of propositions 15 to 20.
22. A timepiece (100) comprising a timepiece component (1) according to any one of propositions 1 to 14 and 21, in particular a timepiece component (1) according to any one of propositions 7 to 14 arranged so that the first surface (111), in particular the first layer (12) and/or the second layer (13), can be seen through the second surface (112) and the substrate (11) by the wearer of the timepiece (100).

In accordance with a second aspect of the invention, objects are defined by the following propositions.
23. A timepiece component (1) comprising:
   a substrate (11) made of an at least partly transparent material,
   a first layer of colored enamel (12) applied onto the substrate (11), notably applied onto the substrate (11) by means of a transfer, in particular applied onto the substrate (11) by means of a chromo decal, and
   a second, finishing layer (13), notably a second, opacifying finishing layer (13) applied at least in part onto the first layer (12) of colored enamel.
24. The timepiece component (1) according to proposition 23, wherein the substrate is made of an inorganic material such as a technical ceramic, quartz, spinel, magnesium aluminate, AlON, YAG, cubic zirconia, mineral glass, polycrystalline alumina, vitroceramic, monocrystalline alumina and/or the substrate has at least locally a real in-line transmittance for light at a wavelength of 550 nm greater than 60% or 70% or 80% or 85%.
25. The timepiece component (1) according to either one of propositions 23 or 24, wherein the substrate has a hardness greater than 800 Hv or 1000 Hv.
26. The timepiece component (1) according to any one of propositions 23 to 25, wherein the second, finishing layer is:
   a layer of enamel, notably a layer of enamel applied by means of a transfer, and/or
   a metal-based layer, notably deposited by PVD, CVD, ALD, PLD, and/or
   a layer of another coating, such as paint.
27. The timepiece component (1) according to any one of propositions 23 to 26, wherein timepiece component (1) is an watch exterior component for a timepiece (100), such as in particular:
   a glass,
   a back,
   a bezel disc,
   a wrist band element, or
   a middle,
or the timepiece component (1) is an internal component for a timepiece (100), such as in particular:
   a dial,
   a flange, or
   a disc for displaying timepiece information.
28. The timepiece component (1) according to any one of propositions 23 to 27, wherein:
   the substrate (11) comprises a first surface (111) and a second surface (112), in particular a second surface (112) parallel or substantially parallel to a first surface (111),
   the first layer (12) and/or the second layer (13) is or are applied onto the first surface (111), and
   the first surface (111), in particular the first layer and/or the second layer applied onto the first surface, can be seen through the second surface (112) and the substrate (11).
29. The timepiece component (1) according to proposition 28, wherein the substrate (11) comprises at least one second recess (15) produced on the second surface (112), notably at least one second recess (15) produced by laser machining.
30. The timepiece component (1) according to proposition 29, wherein the at least one second recess (15) is coated, in particular coated with a metal-based layer, in particular coated with a metal-based layer deposited by PVD, CVD, ALD or PLD.
31. The timepiece component (1) according to any one of propositions 28 to 30, wherein the substrate (11) has an antireflection treatment on the second surface (112).
32. The timepiece component (1) according to any one of propositions 23 to 31 and proposition 28, wherein the substrate (11) comprises at least one first recess (14) produced on the first surface (111) after application of the first and second layers, notably at least one first recess (14) produced by laser machining.
33. The timepiece component (1) according to proposition 32, wherein the at least one first recess (14) is coated, in particular coated with a metal-based layer, in particular coated with a metal-based layer deposited by PVD, CVD, ALD or PLD.
34. The timepiece component (1) according to proposition 32 or 33, wherein the at least one first recess (14) is such that the area of material removed by ablation at the level of a plane perpendicular to a direction in which the at least one first recess is formed is arranged between:
   the surface from which at least one first recess is formed, notably the lower surface (111) or a surface of the first layer (12) or a surface of the second layer (13), and
   a surface defining the bottom of the at least one first recess, evolves in the direction in which the at least one first recess is formed,
and/or
is such that the area of material removed by ablation at the level of any plane parallel to the direction in which the at least one first recess is formed evolves in a direction orthonormal to the direction in which the at least one first recess is formed.
35. The timepiece component (1) according to any one of propositions 32 to 34, wherein the at least one first recess (14) has a millimeter or micrometer or nanometer scale area, notably at the level of a surface defining the bottom of the recess and/or at the level of the surface from which it is formed.
36. A method of producing a timepiece component (1), the method comprising the following steps:
   obtaining a substrate (11) made of an at least partly transparent material,
   applying a first layer of colored enamel (12) onto the substrate (11), notably applying a first layer (12) of colored enamel onto the substrate (11) by means of a transfer, in particular onto the substrate (11) by means of a chromo decal, and
   applying a second, finishing layer (13), notably a second, opacifying finishing layer (13), at least in part on the first layer (12) of colored enamel.
37. The production method according to proposition 36, wherein the application of the second layer is:
an application of a layer of enamel, notably application of a layer of enamel by means of a transfer, in particular by means of a chromo decal, and/or
an application of a metal-based layer, notably by PVD, CVD, ALD, PLD, and/or
an application of a layer of another coating, such as paint.
38. The production method according to either one of propositions 36 or 37, wherein it comprises a step of producing at least one first recess (14) on a first surface (111) of the substrate (11), notably at least one first recess (14) produced by laser machining, and/or it comprises a step of producing at least one second recess (15) on a second surface (112) of the substrate (11), notably at least one second recess (15) produced by laser machining.
39. The production method according to proposition 38, wherein the step of producing at least one first recess and/or the step of producing at least one second recess is or are carried out after the step of application of the first layer of enamel (12) onto the substrate (11), and, in the step of producing at least one first recess and/or in the step of producing at least one second recess, a decoration formed by the first layer of enamel is used as a marker, notably as a machining marker.
40. The production method according to either one of propositions 38 or 39, wherein the method comprises a step of coating the at least one first recess (14) and/or the at least one second recess (15), notably with a metal-based layer, in particular by a metal-based layer deposited by PVD, CVD, ALD or PLD.
41. The timepiece component (1) obtained by use of the method according to any one of propositions 36 to 40.
42. A timepiece (100) comprising a timepiece component (1) according to any one of propositions 25 to 35 and 41, in particular a timepiece component (1) according to any one of propositions 30 to 35 arranged so that the first surface (111), in particular the first layer (12) and/or the second layer (13), can be seen through the second surface (112) and the substrate (11) by the wearer of the timepiece (100).

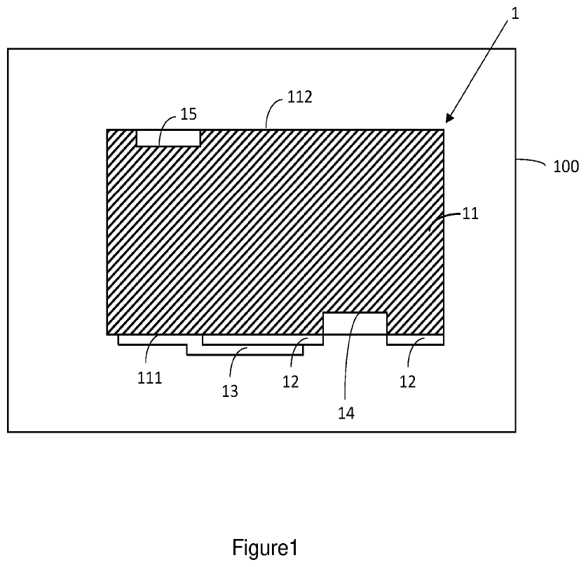

FIG. 1 is a schematic view of one embodiment of a timepiece according to the invention in which a timepiece component is represented in section.

One embodiment of a timepiece 100 is described in detail hereinafter with reference to FIG. 1.

The timepiece 100 is for example a watch, in particular a wristwatch. The timepiece 100 comprises an assembly including:
a timepiece movement, and
a dial.

The assembly is intended to be mounted in a case or in a timepiece case in order to protect it from the external environment.

The timepiece movement may be a mechanical movement, notably an automatic movement, or a hybrid movement. Alternatively, the movement may be an electronic movement.

The timepiece 100, notably the assembly or the casing or the dial or the movement, comprises a timepiece component 1. The timepiece component 1 may for example be an external casing component for the timepiece 100, such as in particular:
a glass,
a back,
a bezel disc,
a wrist band element, or
a middle.

Alternatively, the timepiece component 1 may be an internal component for a timepiece 100, such as in particular:
a dial,
a flange, or
a disc for displaying timepiece information.

The timepiece component 1 comprises:
a substrate 11 made of an at least partly transparent material, and
a first layer 12 of colored enamel applied, notably by means of a transfer, onto the substrate 11, in particular onto a first surface 111 of the substrate 11.

By “layer of colored enamel” is meant a layer of enamel having a coloration visible to the naked eye, whatever the color of that area. The color may therefore notably be achromatic (white, grey or black). Thus a “colored layer” gives its shades to the timepiece component overall or contributes to the shade of the timepiece component. The final color or resulting color of the timepiece component is then a combination of the color of this colored layer, modulated by that of a possible second, finishing layer and that of the substrate if it is not uncolored. The substrate is preferably uncolored and the resulting color of the timepiece component is preferably the shade resulting from the first layer 12 of enamel and the possible second, finishing layer 13. The substrate is preferably made of sapphire, a monocrystalline alumina that is uncolored, and the resulting color of the timepiece component is preferably the shade resulting from the first layer 12 of enamel and the possible second, finishing layer 13.

It is preferable if:
the timepiece component comprises the first layer 12 of colored enamel applied onto the substrate 11 by means of a chromo decal, in particular applied onto the first surface 111 of the substrate 11, and/or
the timepiece component comprises the second layer 13 either as finishing or supporting or opacifiing layer for the decoration. The second layer 13 is applied at least in part on top of the first layer 12. The function of the second layer 13 is notably to provide a backing for the color of the colored enamel.

By “finishing layer” is meant the second of the two stacked layers envisaged, that is to say the one by which the stack is finished or the one that covers the first layer. At the places where there exist a first layer and a finishing layer, the first layer is between the substrate and the finishing layer. The function of the finishing layer is to be a backing layer or an opacifying layer, that is to say a layer reducing or eliminating the transparency of the decoration formed by the colored layer, or more generally to provide a backing for the color of the colored first layer.

By “backing layer” is meant a layer that intensifies or modifies the color of the first layer.

By “opaque layer” or “opacifying layer” is meant a non-transparent layer, notably a layer of enamel that is not transparent. An opacifying layer reduces the transparency of the assembly that it forms with the structure to which it is applied, compared to the transparency of that structure alone. An opaque layer eliminates all transparency of the assembly that it forms with the structure to which it is applied, whatever the transparency of that structure. In practise, it is not possible to see through an opaque layer.

The component is advantageously arranged in the timepiece 100 so that the first layer 12 and/or the second layer 13 can be seen through the substrate 11 by the wearer of the timepiece 100. In other words, the wearer or the user of the watch advantageously sees the side of the first layer in contact with the substrate 11 through the substrate. The component is produced in such a way as to be arranged in such a configuration.

The first layer and/or the second layer create a decoration, that is to say, preferably:
a graphic element, or
a pattern, or
a combination of a plurality of graphic elements and/or patterns, or
a complex design.

This decoration may be monochromatic or formed by a plurality of colors.

The primary function of the first and/or second layer is decorative. The layer(s) may equally well totally conceal the elements located behind the timepiece component 1 so as to expose certain areas by transparency.

According to one variant, when the timepiece component 1 is mounted in the rest of the timepiece, no element comes to contact:
with the second layer 13, or
with the first layer 12 in the absence (possibly the local absence) of a second layer.

The timepiece component 1 has the overall shape of the substrate, the substrate 11 constituting most of the timepiece component 1.

As represented in FIG. 1, the substrate 11 comprises a first surface 111 and a second surface 112, notably parallel or substantially parallel first and second surfaces 111, 112. Each of the first and second surfaces 111, 112 can be of any kind, notably plane, frustoconical, part-toroidal, domed recessed or domed protruding geometry.

For example, in FIG. 1 the surfaces 111 and 112 form faces of the component. These faces are parallel. Alternatively, they could be non-parallel. Assuming that the timepiece component 1 consists of a bezel disc, the first and second surfaces are for example preferably two parallel frustoconical surfaces.

Note that, in FIG. 1, the first layer 12 has been applied onto the first surface 111. The first layer may have been applied to all of the first surface 111 or to only a part of the first surface 111, as represented in FIG. 1.

Likewise, note that, in FIG. 1, the second layer 13 has been applied facing the first surface 111 or vertically aligned with the first surface 111 onto the assembly formed by a portion of the first surface 111 of the substrate and the first layer 12. Like the first layer, the second layer can be applied vertically aligned with all of the first surface 111 or vertically aligned with only a part of the first surface 111, as represented in FIG. 1.

It follows that, depending on the regions of the first surface concerned, it is possible to encounter, in the material of the timepiece component, starting from the first surface 111 and going toward the exterior of the component (perpendicularly to the first surface 111):
the first layer 12, and then the second layer 13, or
the first layer 12 alone, or
the second layer 13 alone, or
no layer (the substrate not being coated in the region concerned of the first surface 111).

Because the substrate 11 is transparent, the first surface 111, in particular the first layer 12 and/or the second layer 13 applied onto the first surface, can be seen through the second surface 112 and the substrate 11.

The substrate is preferably based on or made of an inorganic material such as:
a technical ceramic,
quartz,
spinel,
magnesium aluminate,
AlON (an aluminum oxinitride),
YAG (yttrium aluminum garnet),
cubic zirconia,
mineral glass,
polycrystalline alumina,
vitroceramic,
monocrystalline alumina (sapphire).

The first surface 111 preferably has a mirror polish surface state and/or the second surface 112 preferably has a mirror polish surface. However, at least the first surface 111 and the second surface 112 may have a rough surface state, for example a frosted surface state. This rough surface state may notably be attained by sandblasting and/or satinising and/or brushing; it may be produced by means of a traditional tool and/or by means of a laser. This enables a matt appearance to be conferred on the timepiece component 1. Alternatively, this makes it possible to confer a matt appearance on at least a part of the timepiece component 1, at the level of the part of the timepiece component on which the rough surface state is produced.

The substrate is at least partly transparent. The substrate is preferably transparent and uncolored. More generally, the substrate may be made of a material that is at least partly transparent.

By “at least partly transparent” is meant that:
the substrate comprises at least one transparent region, and/or
at least one region of the substrate or all of the substrate has some degree of transparency, some of the light not being transmitted through the substrate. This covers for example substrates that are translucent or of which the “real in-line transmittance to light at a wavelength of 550 nm is greater than 60%, even 70%, even 80%, even 85%”. In other words, there exists at least one place on the substrate where at least 60%, even at least 70%, even at least 80%, even at least 85% of light at the wavelength of 550 nm is able to pass through the substrate from the second surface to the first surface. According to the paper E6418 v1, extracted from “Les Techniques de l'Ingénieur” and entitled “Céramiques transparentes—Caractéristiques générales et procédés de fabrication”, by Rémy Boulesteix and Alexandre Maitre (10.07.2018), the transparency may in fact be characterized by the measurement of the “real in-line transmittance” of light (RIT). It is effected with a small aperture angle (of the order of 0.5°) using a spectrophotometer. It corresponds to the ratio of the intensity of the light transmitted through a sample of material to the incident intensity. This RIT transparency depends on the thickness (x) of the sample, the wavelength (λ) of the light and is given by the Beer-Lambert law:

RIT(λ)=[1−Rs(λ)]·e^{-α(λ)·x}

where Rs are the losses due to reflection at the two surfaces of the sample; they are of the order of 0.14 to 0.16 and can be evaluated using the formula:

Rs=2·R′(λ)/[1+R′(λ)]

where, at normal incidence, R′={[n(λ)−1]/[n(λ)+1]}²
with n being the refractive index of the material and α(λ) being the attenuation coefficient of the material, which takes into account the optical losses induced by the various sources of dispersion or absorption of the light passing through the material.

For example, the substrate may be colored.

Ways of executing a method of producing a timepiece component 1 as referred to above are described hereinafter.

Generally speaking, the production method comprises the following steps:
procuring a substrate 11 made of an at least partly transparent material, and
applying at first layer 12 of colored enamel onto a surface of the substrate 11, notably by means of a transfer.

It is preferable if:
the application of the first layer 12 of colored enamel onto the substrate 11 can be carried out by means of the application of a chromo decal onto the substrate 11, in particular onto the first surface 111 of the substrate 11, and/or
the method may comprise application of a second, finishing layer 13 at least in part onto the first layer 12 of colored enamel.

In other words, a solution that is the object of the present document relies on a particular use of the enamel deposited by means of chromo decal (or an enamel decal; the expressions “enamel decal” and “chromo decal” are considered equivalent) on a surface intended to be seen by the user of the watch through the substrate 11. This is preferably carried out in two stages:
the first colored enamel layer visible through the substrate represents the decoration,
a second, finishing layer of enamel eliminates the transparency of the decoration or more generally backs the color of the first colored enamel layer. The second enamel layer is preferably opaque. The second enamel layer is preferably opaque and white.

This enables a timepiece component (for example a bezel disc) that is decorated and durable to be obtained in a reliable, robust and repeatable manner.

The second, finishing layer or the decoration backing layer or the opacifying layer may be:
a layer of enamel, notably a layer of enamel applied by means of a transfer, in particular by means of a chromo decal, and/or
a metal-based layer, notably deposited by PVD, CVD, ALD, PLD, and/or
a layer of another coating, such as paint.

According to the invention, to produce the timepiece component 1, for example to produce a bezel disc, the procedure is preferably as follows:
a transparent, preferably sapphire, substrate is obtained,
an enamel decoration is applied by means of a chromo decal onto a surface of the substrate intended to be seen through the substrate,
a finishing or backing or opacifying layer is applied on top of the enamel decoration.

In contrast, in the traditional manner, to produce the timepiece component 1, in particular to produce a bezel disc,
a substrate (generally opaque, in the context of use for timepiece decoration) is obtained,
an underlayer is optionally applied onto the surface of the substrate that would be seen by the user in the absence of a coating on that surface,
an enamel decoration is applied onto said surface of the substrate, possibly covered beforehand by the underlayer,
a glaze (colorless transparent enamel) is applied over the enamel decoration.

In the case of use of the timepiece component in the exterior casing of the watch, it is found that the exterior surface of the component may be very frequently subjected to aggression by the exterior environment. This can degrade the durability of the integrity of the decoration if it is deposited on this exterior surface. The solutions according to the invention offer solutions to this problem by exposing the bare surface of the component to such aggression, thus protecting the decoration placed on a more sheltered surface visible through the transparent substrate.

More specific uses are described in more detail hereinafter.

In a first step, a substrate 11 to be decorated is obtained. The substrate constitutes a part of the timepiece component 1 and preferably most of the timepiece component 1.

This substrate must withstand the enameling conditions. Thus it must withstand temperatures above 500 °C, preferably above 750 °C, enabling vitrification of the enamel, without suffering damage such as deformation or oxidation.

Furthermore, the substrate must preferably have a hardness sufficient to be able to resist abrasion. The material constituting the substrate preferably has a Vickers hardness greater than 800 Hv, even greater than 1000 Hv. This proves all the more important if the component is an exterior casing component that may be exposed to mechanical aggression.

In a second step, the first layer of enamel is applied. To do this, the decoration is applied onto the substrate 11, in particular onto the first surface 111 of the substrate 11. This decoration is preferably applied by means of a chromo decal. One or more chromo decals are preferably applied onto the substrate 11, in particular onto the first surface 111 of the substrate 11, that is to say a layer of enamel is applied by means of a transfer of one or more chromos. Possibly different chromos (for example of different colors) may be applied to different regions of the first surface 111, whether juxtaposed or not, and/or may be at least partly stacked.

The decoration in which the pattern is determined by the chromo is prepared beforehand, for example by screen-printing, lithography, chromolithography, on transfer paper. The chromo consists of a colored film deposited on the transfer paper, one face of which is intended to come into contact with the first surface 111 of the substrate 11 during transfer. The film consists of enamel powder mixed with a polymer producing its cohesion. This film may be transferred (or moved or positioned) from the transfer paper onto the first surface of the substrate to produce a decoration.

For example, the chromo is applied by wetting it in water, in order to separate the film from the transfer paper, before or after application of the film onto the substrate (depending on whether the pattern transferred is on the front or the back). The water and any air bubbles that may be found between the substrate and the film are then driven off, for example, by means of an elastomer squeegee. It is then left to dry, notably to air dry. Finally, the substrate onto which the film is deposited is baked. This film consists of the enamel powder mixed with a polymer, curing serving on the one hand to eliminate the polymer and on the other hand to vitrify the enamel. This curing can be done in an oven, in the open air, at high temperature. The vitrification heat treatment is typically obtained at a temperature above 500 °C, preferably above 750 °C, for a duration of a few minutes, typically 15 minutes. Following this step, the substrate is decorated by the colored enamel layer.

The coefficient of thermal expansion of the enamel used in the chromo must be identical to or very close to or compatible with that of the substrate in order to guarantee appropriate retention (adhesion) and esthetics (that is to say not including cracks, crazing or scaling). The layer 12 being very thin, the tolerance on the difference of the coefficient of thermal expansion between this layer 12 and the substrate 11 is higher than in the case of depositing a thick layer (for example deposited by traditional enameling): thus, in the case of a chromo, a difference of up to 5%, even 10%, even 15%, even 20%, even 25%, may be envisaged. After curing a chromo layer typically has a thickness of the order of 5 to 20 μm, even 7 to 10 μm (which may correspond to a thickness of 40 μm to 80 μm when it is raw). This is why it is considered to be thin compared to a traditionally deposited layer of enamel considered to be thick (typically, more than 100 μm, even more than 200 μm, even more than 300 μm thick after curing). The use of a chromo this thin is made possible by the fact that for equal thicknesses the color of the chromo is more saturated than that of an enamel deposited in the traditional way.

Alternatively, the enamel may be deposited by pad-printing or direct screen-printing type transfer to produce the decoration. Alternatively, the enamel may also be deposited in the traditional manner, by means of a brush for example.

Depending on the wanted aspect, this step of producing the first layer may be repeated. The first layer of enamel constituting the decoration, notably a colored decoration, may therefore be a multilayer of enamel. In this second step, curing is preferably carried out between each application of a layer of enamel onto the substrate 11, in particular on the first surface 111 of the substrate 11 or on the layer applied previously. Alternatively, in this second step, a single curing operation may be carried out once all the layers of enamel have been applied.

In an optional third step the second layer 13 is applied. The second layer is preferably a finishing or backing or opacifying layer. The second layer is a minima translucent and ideally opacifying. The second layer is preferably a uniformly white and/or opaque layer of enamel. The second layer covers at least in part the decorations constituted by the first layer constituted during the second step.

As in the second step, after application of the second layer curing is carried out leading to vitrification of the enamel and possibly elimination of the polymer if the enamel of the second layer is produced using a chromo.

The coefficient of thermal expansion of the enamel used for the second layer 13 must be identical to or very close to or compatible with that of the layer on which it is deposited, for the reasons explained above. For combinations of thin layers 12 and 13, the tolerance on the difference of coefficient of thermal expansion between these layers and the substrate 11 is greater than in the case of depositing a thick layer, which offers more possibilities in terms of adhesion and esthetics.

This second layer or finishing layer 13 is preferably applied by means of a transfer, in particular by means of a chromo decal, as the decoration was in the second step.

Alternatively, the second layer 13 may equally well be applied by other techniques (pad-printing, brush, screen-printing, etc.).

This third step may be carried out in accordance with different variants:
The second layer may be any color. Any enamel color may be envisaged.

The color of the second layer may be different depending on the location at which it is applied onto the decoration and/or onto the substrate.
The opacity of the second layer may be varied: different levels of opacity may be envisaged, from translucent to totally opaque, depending on the nature of the finishing layer or layers. The target opacity could equally well be different depending on where the finishing layers are applied onto the decoration and onto the substrate.
The chemical nature of the finishing layer could be varied: any kind of inorganic material meeting the criteria of opacity and of resistance to environmental stresses could be envisaged. The chemical nature of the finishing layer may equally differ depending on where it is applied onto the decoration. For example:
   enamel charged with luminescent zirconia powder or another luminescent inorganic material, or
   metallization, or
   a metal-based layer, notably of nitrides, deposited for example by PVD (physical vapor deposition), CVD (chemical vapor deposition), ALD (atomic layer deposition), PLD (pulsed laser deposition), or any other suitable process,
may be used as a finishing layer.
The method of application of the finishing layer can therefore be a method by means of a transfer, brush, screen-printing, PVD, CVD, ALD, PLD, etc., depending on the nature of the layer, its thickness, the target level of accuracy (in terms of location, thickness, distribution, etc.).
The finishing layer is a minima positioned over some of the locations decorated during the second step.
The distribution of the finishing layer may vary over the first surface 111:
   the finishing layer may be positioned only over the places decorated during the second step and, in this case, it may be applied onto all or part of the decoration,
   the finishing layer may additionally be positioned over places not decorated during the second step and, in this case, it may be on some or all of the undecorated places.
The thickness of the finishing layer may vary:
   this thickness can define its level of opacity, which may be chosen as a function of where it is applied,
   this thickness may modulate the shade resulting from the stacking of the first and second layers 12 and 13.

Depending on how the method is executed, the application of the second layer may be:
application of a layer of enamel, notably application of a layer of enamel by means of a transfer, in particular by means of a chromo decal, and/or
application of a metal-based layer, notably by PVD, CVD, ALD, PLD, and/or
application of a layer of another coating, such as paint.

Numerous variant embodiments may be considered. Notably, one or more recesses may be formed on the first surface 111 of the timepiece component and/or one or more recesses may be formed on the second surface 112 of the timepiece component.

One or more recesses on the first surface and/or on the second surface may be formed before the second and third steps mentioned above, and/or one or more recesses on the first surface and/or on the second surface may be produced between the second and third steps mentioned above, and/or
one or more recesses on the first surface and/or on the second surface may be formed after the second and third steps mentioned above.

When a recess is formed at the level of the first surface after curing the first layer, the recess may affect:
only part of the thickness of the first layer, or
all of the thickness of the first layer, or
all of the thickness of the first layer and part of the thickness of the substrate 11.

When a recess is produced at the level of the first surface after production of the first and second layers, the recess may affect:
only part of the thickness of the second layer, or
all of the thickness of the second layer, or
all of the thickness of the second layer and part of the thickness of the first layer, or
all of the thickness of the second layer and all of the thickness of the first layer, or
all of the thickness of the second layer and all of the thickness of the first layer and part of the thickness of the substrate 11.

Accordingly, depending on the variant embodiment, at least one first recess 14 may be produced on the first surface 111, notably at least one first recess 14 produced by laser machining, and/or at least one second recess 15 may be produced on the second surface 112, notably at least one second recess 15 produced by laser machining. The method preferably comprises a step of coating the at least one first recess 14 and/or the at least one recess 15, notably with a metal-based layer, in particular a metal-based laser deposited by PVD, CVD, ALD or PLD.

A recess can naturally have any shape or geometry.

In particular, the thickness of the material machined to form a recess may be the same whatever the location of the recess. Thus the depth of a recess may be constant and the distance (as measured perpendicularly to the surface from which the recess is formed) that separates:
the surface from which the recess is formed (which may be the lower surface 111, just like the surface 112, or a surface of the layers 12 or 13),
a surface defining the bottom of the recess,
may be the same and correspond to the depth of the recess, whatever the location in the recess.

Alternatively, the depth of a recess may evolve, that is to say may evolve according to the location or locations in the recesses concerned. In particular, the height (or the depth) of the flanks or the walls that define the contour of a recess may evolve and is therefore not necessarily constant. Furthermore, the surface defining the bottom of the recess is therefore not necessarily parallel to the surface from which it is formed.

The flanks or the walls can equally be at a (constant or variable) oblique angle to the surface from which the recess is formed, for example, and/or to the surface defining the bottom of the recess. In other words, the angle between:
the direction in which the recess is formed, and
the normal to the surface from which it is formed
may be any angle, enabling any type of design.

More generally, the area of material machined or removed by ablation at the level of any plane perpendicular to the direction in which the recess is formed, arranged between:
the surface from which the recess is formed (which may be the lower surface 111, just like the surface 112, or a surface of the layers 12 or 13), and
a surface defining the bottom of the recess,
may be constant or not depending on the position concerned of the plane between the surface from which the recess is formed and a surface defining the bottom of the recess. In other words, the area of material removed by ablation at the level of a plane perpendicular to the direction in which the recess is formed, arranged between the surface from which the recess is formed and a surface defining the bottom of the recess, may evolve depending on the direction in which the recess is formed. Furthermore, the area of material removed by ablation at the level of any plane parallel to the direction in which the recess is formed may be constant or vary. In other words, the area of material removed by ablation at the level of any plane parallel to the direction in which the recess is formed may evolve in the direction orthonormal to the direction in which the recess is formed.

The areas concerned of the material removed by ablation may be of the order of a millimeter scale (for example between 1 mm² and 15 mm²), a micrometer scale (for example between 1 μm² and 15 μm²), a nanometer scale (namely any area less than 1 μm²), or the areas concerned of material removed by ablation may the surfaces one dimension of which is of the order of magnitude:
millimetric (between 0.5 mm and 10 mm inclusive, even between 1 mm and 5 mm inclusive), or
micrometric (between 0.5 μm and 200 μm inclusive, even between 1 μm and 50 μm inclusive), or
nanometric (between 50 nm and 500 nm inclusive, even between 200 nm and 400 nm inclusive). In other words, a recess can therefore have a millimetric or micrometric or nanometric area, notably at the level of a surface defining the bottom of the recess and/or at the level of the surface from which it is formed.

These variants may be combined to create different optical effects, notably to produce shades and gradations of colors.

Furthermore, this machining or removal by ablation may be carried out in the chromo added before or after curing.

Examples are described in detail hereinafter relating to the production of:
a glass,
a two-colored bezel, and
a two-colored bezel with metallized recesses.

The first example concerns the production of a watch glass, notably made of sapphire, featuring two shades of red.

The first step consists in obtaining a watch glass, for example made of sapphire. The lower surface 111 and/or the upper surface 112 are plane, for example.

The second step consists in producing the decoration (the first layer 12). In this step a red chromo is obtained (prepared beforehand, notably by screen-printing a colored enamel onto transfer paper). On immersing it in deionized water, the colored enamel film is detached from the transfer paper. This film is then applied onto the lower surface 111 of the watch glass (the face intended to be located inside the watch case). The watch glass is then cured at 800 °C for 15 minutes in an oven. The rate of rise in temperature is high (approximately 30 minutes) and cooling is effected over an equivalent duration, so that the complete heat treatment enabling vitrification of the enamel lasts less than one hour and a half.

The third step consists in producing the finishing layer (the second layer 13). In this third step a layer of white and opaque enamel is applied to a part of the decoration layer previously deposited during the second step. The finishing layer is for example a layer of enamel applied by means of a chromo in the same manner as the decoration was applied during the second step. This is typically followed by curing the watch glass at 800 °C for 15 minutes in an oven. The rate of rise in temperature is high (approximately 30 minutes) and cooling is effected over an equivalent duration, so that the complete heat treatment enabling vitrification of the enamel lasts less than one hour and a half.

A watch glass is then obtained featuring two shades of red:
a first shade of red (translucent red) at the places where only the red enamel was applied. The appearance is translucent and light. At the location of this part of the decoration, it is possible to see through the glass; and
a second shade of red (opaque red) at the places where a finishing layer of opaque white enamel was deposited on the red enamel. The appearance is red, more saturated and opaque. It is not possible to see through the glass at these places.

It is therefore possible to propose diverse decorations produced in accordance with this same principle, such as watch glasses with fine translucent or transparent decorations in places, and fine opaque decorations at other places, that constitute for example signs, graduations or hour markers.

The second example concerns the production of a bezel disc in two-color red and black sapphire.

In the first step, a sapphire bezel disc is obtained, with a mirror polish surface state. Its upper surface 112 (that will be seen directly by the user when the disc is in place on the timepiece) is for example domed. The lower surface 111 (which will be seen indirectly, that is to say through the substrate, by the user when the disc is in place on the timepiece) is for example plane.

In the second step, the decoration is produced by applying the first layer. To this end, chromos (one black and one red, prepared beforehand, notably by screen-printing enamel onto transfer paper) are obtained to produce the part intended to be black and the part intended to be red. The chromos are immersed in deionized water so that the transfer papers are detached from the colored enamel film. These films are then placed on the lower surface 111. The black film is positioned over one half of the lower surface of the sapphire disc and the red film is positioned over the other half of the lower surface of the sapphire disc. Curing at 800 °C for 15 minutes is then carried out in an oven. The rate of rise in temperature is high (approximately 30 minutes) and cooling is effected over an equivalent duration, so that the complete heat treatment enabling vitrification of the enamel lasts less than one hour and a half. Alternatively, a single chromo comprising a black zone and a red zone may be used.

One or more markers may be produced on the substrate to assist with positioning the film of the chromo on the first surface 111. The marker or markers may advantageously be positioned on the first surface or on a surface adjacent to the first surface. The marker or markers may advantageously consist of a material that disappears during vitrification of the enamel.

In the third step a finishing layer is produced. To this end, a layer of white and opaque enamel is applied over all of the part previously enameled during the second step. The finishing layer is also obtained using a chromo, and applied in the same manner as the decoration during the second step. The obtained lower surface 111 seen through the substrate has a first half of opaque red color and a second half of opaque black color.

The bezel disc, with the opaque decoration, can then be clipped into a steel ring to constitute a bezel. Technical parts of the bezel may be highlighted by the areas that have remained transparent after the decorations are produced on the lower surface 111 of the disc.

The third example concerns the production of a red and black two-color sapphire bezel disc with metallized recess.

The decoration of the disc obtained in the second example described hereinabove may be continued to obtain the third example comprising metallized recesses or engravings.

A disc obtained by the procedure described in the second example is used.

The upper surface 112 is afterwards covered with a protective resin.

Recesses are thereafter produced on the upper surface 112, through the resin, notably using a femtosecond laser.

A metal, notably platinum, coating is thereafter deposited on the upper surface, by PVD (physical vapor deposition).

The layer of resin is thereafter dissolved. The metal coating therefore remains only at the bottom of the recesses.

A sapphire disc is obtained of two-color appearance, with saturated and opaque colors. The etched signs (consisting of the recesses) on the upper surface 112 have a metallic appearance following the physical vapor deposition.

As in the second example, the bezel disc can then be clipped into a steel ring to constitute a bezel. Possible technical parts may be exposed by the areas that have remained transparent after decorations are produced on the lower surface.

Thanks to the solutions described, it is possible to obtain both the advantages of the chromo decoration and those of the sapphire substrate in a synergistic manner because of the innovative configuration proposed. The chromo decoration gives access to esthetic advantages because of the wide palette of enamel colors available, with no design limitation (only the resolution of the chromo has to be taken into account; for example, when it is produced by screen-printing, the resolution is that of the mesh of the frame chosen). The enamel deposited by the chromo technique has very good adhesion. To this end it is nevertheless necessary to match the coefficients of thermal expansion of the enamel and that of the substrate. Enamel offers the advantage of guaranteeing possible use of the component produced over very wide amplitudes of temperature, as well as excellent resistance to thermal shock, UV rays, moisture (even combined with high temperatures) and chemical products. The chromo is not reserved to plane surfaces. In fact, the film can be deposited on surfaces with a relief (for example, it is suitable for a disc having a frustoconical or domed surface). The chromo is not reserved to surfaces delimited by sides, because the film is a coherent object (unlike the traditional enamel, deposited in the form of a fluid, so that it is necessary to provide sides to retain it at the location for which it is intended). Chromo deposition is more repeatable and automatable than traditional enameling with a brush. It is therefore possible to obtain high quality in series production.

Sapphire is the preferred material for producing the substrate 11. Sapphire in fact has excellent resistance to scratching, because of its very high hardness. For the timepiece component application, the fact that the upper surface 112 of the component (the surface exposed to possible mechanical aggression) is made of sapphire enables a solution to be offered that is at least as good as the current ceramic solutions. In fact, the hardness of sapphire is equivalent to that of the polycrystalline alumina used to produce some components and greater than that of the zirconia used to produce other components.

Furthermore, sapphire has an excellent failure stress. To produce a timepiece component, the fact that the upper surface 112 of the component is made of sapphire makes it possible to offer a solution at least as good as the solutions known at present. In fact, on average, the failure stress of sapphire has a value of about 1700 MPa along the axis A and about 3500 MPa along the axis C, which is greater than the failure stress of zirconia (about 1300 MPa), itself greater than that of polycrystalline alumina (about 500 MPa).

New advantages are obtained by the combination of sapphire and chromo in the innovative configuration proposed (application of the chromo to a surface visible through the substrate, enabling the use of an opacifying finishing layer):
The proposed solution, combining sapphire and enamel decoration, is entirely inorganic, and therefore not degradable by UV rays, over very wide temperature amplitudes, moisture (even combined with high temperatures), chemical products, without having to seal the decoration. Furthermore, it is resistant to abrasion.
The decoration being at a distance from the upper surface 112 of the substrate directly visible to the user (decoration under the sapphire), a deep esthetic and visual effect results from this disposition. This effect can be further amplified by the rounded recessed geometry or the domed protruding geometry of the surface of the substrate directly visible to the user.
The design enables superposition of treatments and effects. For example:
   a treatment may be applied onto the upper surface 112 of the sapphire, notably an antireflection treatment, and/or
   recess may be formed on the upper surface 112 and/or the lower surface 111 of the sapphire.
Esthetic effects can be chosen because of the colors of the colored layer and where it is positioned.
The levels of transparency and the esthetic effects can be varied by dosing the opacity and the color of the finishing layer, and where it is positioned can be varied. For a masking function, opaque layers may be formed.

The solutions described are very favorable from an industrial point of view in the sense that they make it possible to obtain a high production quality because of the repeatability of the method of producing the timepiece component.

In particular, the solutions described enable treatment of the upper surface 112 of the sapphire after executing the steps of obtaining a substrate, applying a first layer and applying a second layer. To carry out this treatment, it is possible to benefit from the transparency of the substrate and consequently to locate the position of the treatment of the upper surface 112 with reference to the decoration produced on the lower surface 111. This enables the positioning of the treatment to be carried out on the upper surface by observation/recognition of the shape of the decoration. It is therefore possible to produce one or more recesses on the upper surface 112, at precise locations relative to the enamel decoration previously produced on the lower surface 111 of the timepiece component, that is to say to produce one or more recesses on the upper surface 112 using a decoration formed by the first layer of enamel as a marker, notably as a machining marker. Conversely, it is possible to produce an enamel decoration on the lower surface 111 of the timepiece component at precise locations relative to one or more recesses previously produced on the upper surface 112, that is to say to produce a decoration formed by the first layer of enamel using as markers one or more recesses on the upper surface 112.

The solutions described also make it possible to produce many variants of the components easily. In fact, starting with a series of identical substrates 11 and depending on the options adopted to produce the first layer and the second layer, it is possible in the end to obtain timepiece components with highly varied appearances.

To summarize, to obtain a timepiece component that is decorated, durable and variable without limitation on the choice of graphic elements, patterns, shapes and colors or combinations thereof, with any spatial distribution (that is to say with no design limitations), it is proposed to produce a first layer of enamel on a partly transparent or transparent substrate, this first layer of enamel being intended to be seen through the substrate. The first layer of enamel can be produced by means of a transfer, notably by means of a chromo decal, and/or the first layer of enamel may be at least partly covered with a second, opacifying layer, notably a white, opacifying second layer.

In the present document, “by means of a transfer” means any method enabling the enamel to be transferred (or moved or positioned) onto a surface to be enameled in accordance with a previously established design, that is to say already constituted prior to transfer (or move or position). This may include:
pad-printing, or
direct screen-printing, or
programmed deposition by inkjet printing.

When it is a question of moving a film (enamel powder mixed with a polymer) from a transfer paper onto a surface to be enameled, this transfer can be a decal, notably a waterslide decal.

Thus a reversed use of chromo-type enameling is obtained using the second, opacifying layer to cooperate with the first layer in order to participate in the creation of the decoration. The user therefore:
sees the first layer, possibly formed by the use of a chromo, through the substrate, and
possibly, sees the second layer through the substrate and the first layer.

In a use in accordance with the prior art of a chromo, the result is completely different: in fact, the user usually sees the decoration through a layer of uncolored and transparent enamel (covering) that covers it to protect it, the enamel being applied on an opaque substrate.

1. A timepiece component comprising:
a substrate made of an at least partly transparent material,
a first layer of colored enamel applied onto the substrate, and
a second, finishing layer.

2. The timepiece component as claimed in claim 1, wherein
the substrate is made of an inorganic material, and/or
the substrate has at least locally a real in-line transmittance for light at a wavelength of 550 nm greater than 60%.

3. The timepiece component as claimed in claim 1, wherein the substrate has a hardness greater than 800 Hv.

4. The timepiece component as claimed in claim 1, wherein the second, finishing layer is:
a layer of enamel applied by means of a transfer, and/or
a metal-based layer deposited by PVD, CVD, ALD, PLD, and/or
a layer of paint.

5. The timepiece component as claimed in claim 1, wherein
(i) the timepiece component is an exterior casing component for a timepiece selected from the group consisting of:
a glass,
a back,
a bezel disc,
a wrist band element, and
a middle,
or
(ii) the timepiece component is an internal component for a timepiece selected from the group consisting of:
a dial,
a flange, and
a disc for displaying timepiece information.

6. The timepiece component as claimed in claim 1, wherein:
the substrate comprises a first surface and a second surface,
the first layer and/or the second layer is or are applied onto the first surface, and
the first surface can be seen through the second surface and the substrate.

7. The timepiece component as claimed in claim 6, wherein the substrate comprises at least one second recess produced on the second surface.

8. The timepiece component as claimed in claim 7, wherein the at least one second recess is coated with a metal-based layer deposited by PVD, CVD, ALD or PLD.

9. The timepiece component as claimed in claim 6, wherein the substrate has an antireflection treatment on the second surface.

10. The timepiece component as claimed in claim 6, wherein the substrate comprises at least one first recess produced on the first surface after application of the first and second layers.

11. The timepiece component as claimed in claim 10, wherein the at least one first recess is coated with a metal-based layer deposited by PVD, CVD, ALD or PLD.

12. The timepiece component as claimed in claim 10, wherein the at least one first recess is so that an area of material removed by ablation at a level of a plane perpendicular to a direction in which the at least one first recess is formed:
(i) is arranged between
the surface from which the at least one first recess is formed, and
a surface defining the bottom of the at least one first recess,
and evolves in the direction in which the at least one first recess is formed,
and/or
(ii) evolves in a direction orthonormal to the direction in which the at least one first recess is formed.

13. The timepiece component as claimed in claim 10, wherein the at least one first recess has a millimeter scale area at a level of a surface defining the bottom of the recess and/or at a level of the surface from which the at least one first recess is formed.

14. A method of producing a timepiece component, the method comprising:
providing a substrate made of an at least partly transparent material,
applying a first layer of colored enamel onto the substrate, and
applying a second, finishing layer.

15. The method as claimed in claim 14, wherein the application of the second layer is:
an application of a layer of enamel, and/or
an application of a metal-based layer, and/or
an application of a layer of paint.

16. The method as claimed in claim 14, wherein the method comprises:
producing at least one first recess on a first surface of the substrate, and/or
producing at least one second recess on a second surface of the substrate.

17. The method as claimed in claim 16, wherein
the producing of the at least one first recess and/or the producing of the at least one second recess is or are carried out after the applying of the first layer of enamel onto the substrate and,
in the producing of the at least one first recess and/or in the producing of the at least one second recess, using a decoration formed by the first layer of enamel as a machining marker.

18. The method as claimed in claim 16, wherein the method comprises coating the at least one first recess and/or the at least one second recess.

19. A timepiece comprising a timepiece component as claimed in claim 6 arranged so that the first surface can be seen through the second surface and the substrate by a wearer of the timepiece.

20. The timepiece component as claimed in claim 1, wherein the second, opacifying finishing layer is applied at least in part onto the first layer of colored enamel.
